(19) United States
(12) Patent Application Publication
(10) Pub. No.: US 2006/0275017 A1
(43) Pub. Date: Dec. 7, 2006

(54) Apparatus and method for optically detecting an object

(75) Inventors: Wolfgang Sulik, Asslar (DE); Hans-Artur Boesser, Breidenbach (DE)

Correspondence Address: SIMPSON & SIMPSON, PLLC, 5555 MAIN STREET, WILLIAMSVILLE, NY, 14221-5406, US

(73) Assignee: Vistec Semiconductor Systems GmbH, Wetzlar (DE)

(21) Appl. No.: 11/437,953

(22) Filed: May 19, 2006

(30) Foreign Application Priority Data
May 20, 2005 (DE) 10 2005 023 973.0

(51) Int. Cl. G02B 6/00

(52) U.S. Cl. 385/147

(57) ABSTRACT

Apparatus and method for optically detecting an object. The apparatus includes a light source to illuminate an object, an illumination optical path, a detection optical path, imaging optics, a detection means, wherein the imaging optics are arranged in the detection optical path and wherein light from the object can be imaged onto the detection means with the aid of the imaging optics, an adjustment means is provided, by means of which at least one imaging optical component, arranged in the illumination optical path or in the detection optical path, is rotatable about its respective optical axes, or is pivotable with respect to the optical axis of the optical path in which the optical component is arranged, and is translatable in a direction transverse to the optical axis, to detect an object with the aid of the optical component in a rotated, pivoted or translated state.

### CROSS REFERENCE TO RELATED APPLICATIONS

This patent application claims priority of German Patent Application No. 10 2005 023 973.0, filed on May 20, 2005, which application is incorporated herein by reference.

### FIELD OF THE INVENTION

The present invention relates to an apparatus for optically detecting an object. The apparatus comprises a light source, an illumination optical path, a detection optical path, imaging optics, and a detection means. An object can be illuminated by means of the light source. The imaging optics are arranged within the detection optical path. Light coming from the object can be imaged onto the detection means by using the imaging optics. The present invention further relates to a method for optically detecting an object.

### BACKGROUND OF THE INVENTION

In the prior art it has been common to align fixed, and, in particular, error-minimized, optical components as precisely as possible along an optical axis, which in an optical apparatus is provided for example by the optical axis of the illumination optical path. This optical axis coincides with the theoretically calculated optical axis from the optics design, i.e., the optics calculation, only in the ideal case. In practice, this optimal theoretic optical axis is never exactly achieved even with optimized manufacturing conditions and precise assembly in the optical devices. Such devices are, for example, microscopes, which are commercially manufactured on an industrial scale and which comprise a stand or housing construction on which the optical components are mounted. The alignment of the optical components is usually done by precisely aligning the mounts of the optical components in the device or in its stand with one or more auto-collimating telescopes and target markings. The mounts of the optical components are thus precisely arranged with respect to each other and fixed on the apparatus in their spatial positions. During completion of the manufacturing process it is assumed that the optical components are centered to a sufficient degree so that the optical components are centered with respect to the adjusted mechanics and that the screw insertion surfaces for the optical components are planar.

It is also assumed that the center of each optical component and the center of the mount of each optical component coincide. This coincidence is within certain tolerances, which cannot always be precisely determined. Furthermore it is assumed that the errors of the optical components occur with a radial symmetry, which is not usually the case.

The individual optical components are centered and adjusted within themselves before assembly in the optical devices in such a way that the optical device has an overall optical error which is as small as possible. This internal adjustment is carried out using a different optical system, such as a calibrating interferometer. The result is that errors inherent in the calibrating interferometer itself are compensated by each optical component to be adjusted and is therefore transferred to the optical component itself In the end, an optical component has itself a residual error.

Optical components as used with the present invention are, in particular, optical imaging assemblies or units, for example, a collector, transportation optics, intermediate optics, a condenser, a lens, a tubular lens or tubular optics, reenlargement optics or a light mixer configured, for example, in the form of a micro lens matrix. An apparatus as used in the context of the present invention is, in particular, any optical device, with which an object can be optically detected or imaged, wherein the imaging should be carried out with a resolution or quality which is as high as possible.

### SUMMARY OF THE INVENTION

It is therefore an object of the present invention to provide and improve an apparatus and method of the initially mentioned type, wherein the overall error of the optical imaging of the apparatus is further reduced and ideally minimized.

The apparatus according to the present invention and of the initially mentioned type solves the above object by the features of Claim 1. Accordingly, an apparatus of this type has an adjustment means with which at least one optical imaging component, in particular imaging optics, is arranged within the illumination optical path and/or within the detection optical path and configured to be rotatable about its optical axis and/or configured to be pivotable with respect to the optical axis of the optical path in which the optical components are arranged, and/or to be translatable in a direction transverse to the optical axis, to detect an object by means of the optical component which has been adjusted by rotating, pivoting and/or translating.

In CD metrology measurements, i.e., in measuring the structural widths or line widths (“critical dimension”) of structures on substrates, when carrying out a plurality of measurements in the x and y dimensions on line structures as objects, it has been observed that the measurements have differing results. Herein the deviations were larger than would have been expected from the overall measuring scenario. In particular, there were differing measurement values before and after rotating the measurement sample, and therefore its corresponding line structure, by 90 degrees, wherein the measured profiles of structures of a known form were asymmetrical. By the use of one lens there was a considerably higher asymmetry of the measuring values than expected even though it was better qualified due to an interferometer test during the manufacturing of the lens. While a different lens reflected the symmetry change associated with the rotation of the sample in profile, this influence could hardly be seen with the first lens. In contrast, rotating the object with the first lens showed a considerably stronger effect.

It has therefore been recognized according to the present invention that the residual overall error of the optical imaging by the apparatus can be reduced and ideally minimized, in particular, in that at least one optical imaging component is arranged to be rotatable, pivotable and/or translatable with respect to the apparatus. This would allow an optical component configured to be rotatable, pivotable and/or translatable to be adjusted and aligned in such a way that the residual error of the optical component is largely compensated by the residual errors of the other optical components of the apparatus. In other words, the optical components of the apparatus according to the present invention are provided with a plurality of additional degrees of freedom so that a reduction of the overall imaging error of the apparatus can be achieved.

Basically, the rotation, pivoting or translation of at least one optical component is carried out during the manufacture or production of the apparatus so that the overall optical error of the apparatus is thereby minimized. Depending on each application it may be necessary to carry out the rotation, pivoting or translation according to the present invention of at least one optical component of the apparatus, also during the operation of the apparatus, because in the respective applications the most stringent requirements are demanded of the overall optical system. One example of such an application is a coordinate measurement device, such as it is disclosed, for example, in DE 198 19 492 and which is usually operated in a climatic chamber. Herein at least the temperature, in some climatic chambers also the air humidity, is maintained constant. The control accuracy of the temperature and air humidity has its technical limits. It is impossible with reasonable effort to produce a hermetically sealed chamber for maintaining the air pressure constant, in particular because, in the example with a coordinate measurement device, the measurement object had to be simply and quickly exchanged. Operating a charge opening in itself causes rapid air pressure variations. These varying environmental conditions can cause the optical components arranged on the apparatus or on the coordinate measurement apparatus to change their relative positions with respect to each other, if only very slightly, and thus to change the imaging characteristics of the coordinate measuring device. It is therefore particularly preferable to configure the adjustment means in such a way that when the optical component is rotated, pivoted and/or translated, a focusing adjustment of the optical component or the overall apparatus remains essentially unchanged. As a result the optical component could be aligned by rotation, pivoting and/or translation also in the course of the operation of the apparatus, for example, between individual object detection processes, and it can be largely avoided that the object goes out of focus.

A critical, adjustably arranged, optical component is the imaging optics, in particular a microscope lens. An ultrafine resolution microscope lens could be provided, such as it is disclosed, for example, in German patent application DE 10 2004 048 062. Since usually the microscope lens is the most sensitive part of the apparatus having the greatest number of mutually adjustable lenses, it is particularly suitable to rotate, to pivot and/or to translate the microscope lens with the aid of the adjustment means. By rotating, pivoting and/or translating it is possible to optimally align the microscope lens with respect to the other sometimes fixedly installed optical components of the apparatus, and the error of the optical imaging can therefore be minimized.

Alternatively or additionally a condenser and/or transportation optics and/or a light mixer can be provided as an adjustable optical component in the illumination optical path. Tubular optics and/or reenlargement optics and/or an optical compensation element arranged in the detection optical path could also be considered. If all the above optical components of the apparatus are each arranged so that they can be aligned, for example, with the aid of correspondingly formed adjusting means the degrees of freedom available for error minimization of the overall optical system of the apparatus according to the present invention are maximized, in particular if each of the adjustable optical components is configured in a rotatable, pivotable and translatable manner.

In case the optical component is to be pivoted by the adjustment means, it is preferably provided that the adjustment means is configured such that the optical component can be pivoted about at least two pivoting axes of differing spatial orientation. The term “differing spatial orientation of the pivoting axes” as used herein should be construed, in particular, to mean that the directional vectors of the pivoting axes are independent of each other in the mathematical sense of linear algebra. For example, two pivoting axes could be vertical to each other and have an intersection point. Pivoting could be by means of a piezo actuator and/or by means of at least one mechanical actuator, wherein, by means of a piezo actuator in combination with a suitably formed mechanical lever, an extremely reproducible and precise pivoting is possible on the one hand and a high mechanical resolution is achievable on the other hand. A pivoting unit could be formed, for example, as disclosed in German patent application DE 100 04 661. With such a pivoting unit an optical component can be pivoted about two pivoting axes of differing spatial orientations in such a way that a light beam passing through the optical component can be pivoted about a point remote from the pivoting unit coinciding, for example, with the focus of tubular optics or lying within an intermediate image plane. Alternatively it is also conceivable for the optical component to be pivoted with the aid of an adjustment means which facilitates mounting on the apparatus in the manner of a cardanic suspension or adjustment and by means of which the optical component can be pivoted.

In one particularly preferred embodiment of the present invention, an adjustment of one or more optical components can be carried out in such a way that an error of the optical components of the apparatus can be minimized. As mentioned above, this is done, in particular, during manufacture or production of the apparatus according to the present invention. It is also conceivable, however, to carry out the error minimization immediately after powering-on of the apparatus according to the present invention or at the beginning of each measurement series or object detection, i.e., during the operation of the apparatus. In particular, it could be carried out between two object detection processes. An adjustment of at least one optical component could be carried out, in particular, as a calibration step. If necessary, a calibrating object of a known structure and/or dimension could be inserted and detected in the optical path of the apparatus. Error minimization of the optical components of the apparatus should be carried out, in particular, with the application of inspecting and/or coordinate measurements on substrates of the semiconductor industry so that measurement values or object images obtained with the apparatus have a minimum value of the so called X-Y bias. The X-Y bias represents the difference of the measured average values of a plurality of identical structural widths measured in the center of the image.

The following remarks relate to microscope lenses in particular. They can be applied, however, to any other optical components of the apparatus according to the present invention, in particular, if such optical components are comprised of a plurality of individual optical components, such as lenses.

It is particularly preferred for the optical component to comprise a support for at least one optical component and a mounting interface. The optical component is received by or in the support. The optical component received by the support has an optical axis. The optical component can be mounted on a mounting position provided on the apparatus via the mounting interface. This support is rotatable, such as a rotating body, relative to the mounting interface, so that the optical component received by the support can be rotated about the optical axis in a state of the optical component being mounted on the apparatus. In the operating state the mounting interface is arranged on the apparatus in a non-rotatable manner.

The mounting interface may comprise a thread or an interface similar to a bayonet fastener, with the aid of which the optical component can be mounted on the apparatus. In case the optical component is configured as a microscope lens, the lens sleeve of the microscope lens corresponds to such a support. The mounting interface of the microscope lens will usually have a thread which is compatible with the microscope in question. It should also be noted that a mounting interface in the form of a thread is not for rotating each optical component in the manner according to the present invention, since the purpose of the thread is for mounting the optical component and is usually twisted up to a point where it comes into abutment with an abutment surface and is therefore fixed. Only then is the optical component properly mounted on an optical apparatus. In this state there should be no rotating of the optical component by means of the thread of the mounting interface about the optical axis during operation of the apparatus, since this would usually cause the respective optical component to come out of focus, since depending on the pitch of the thread of the mounting interface, rotating the mounting interface would cause a movement of the whole of the optical component in the screwing direction, i.e., along the optical axis. The rotation according to the present invention of the optical component relative to the apparatus or about its optical axis is therefore not carried out by rotating the mounting interface of the optical component with respect to the apparatus.

The adjustment means, with the aid of which the optical component is rotated about the optical axis, could be a ball bearing, a grease bearing and/or a journal bearing. Preferably the type of bearing is selected such that optimal precision can be achieved with the alignment of the optical component. Ideally the bearing selected has only negligible play so that the adjustment or alignment according to the present invention of the optical component can be carried out in a reproducible manner.

In a practical realization the adjustment means could be a sleeve at least partially extending over the support of the optical component in the direction of the optical axis. Preferably the sleeve comprises the mounting interface. At its side facing the support, the sleeve can have a shoulder, for example, towards the inside. The support can have another shoulder on its side facing the sleeve, for example, towards the outside. In the assembled state of the support and the sleeve, the two shoulders can come into abutment with each other via a bearing, which is preferably effective in the direction of the optical axis or in the direction of the common abutment surface. At least one area can be provided between the sleeve and the support which can be configured as a journal or grease bearing.

The angular range about which the support is rotatable with respect to the mounting interface can be from 0 degrees to at least 90 degrees. This angular limitation with respect to the rotation of the optical component relative to the apparatus can be defined from the structural point of view by means of at least one end stop provided on the support which comes into engagement with a catch arranged on the sleeve as a rotary limitation. Preferably, however, at least one full rotation of the optical components relative to the apparatus is provided so that a corresponding angular range extends at least from 0 degrees to 360 degrees.

As mentioned above, an apparatus can be an optical device by means of which an object can be optically detected or imaged. In a practical application the apparatus can be in the form of a coordinate measurement apparatus, such as it is disclosed, for example, in DE 198 19 492, in the form of an inspection microscope for inspecting substrates for the semiconductor industry, in the form of a high resolution microscope, a confocal scanning microscope or a double confocal scanning microscope. Since usually the most stringent requirements with respect to the quality and the imaging characteristics and/or the resolution to be achieved are demanded of apparatuses of this type, an apparatus in which at least one optical component is adjustably arranged in the manner according to the present invention will more likely meet these stringent requirements, since the overall error of the optical imaging of the apparatus can be minimized in a particularly advantageous way.

Generally the optical component comprises at least one lens, which is mounted in a mounting ring. This mounting ring is received in the support, in particular, in a precise fit. In case the optical component has the form of a microscope lens, the lens is usually blocked within the mounting ring or held on the mounting ring itself by a crimped flange (a so-called flange mount). Alternatively, a mount could be configured, in particular, as it is disclosed in the currently not yet published German patent application DE 10 2004 048 064. According to this application a lens is fixed in its mount by means of a resilient ring so that mechanical stresses in the lens due to the lens mount are largely avoided. Imaging errors due to mechanical stresses in the optical components can thus be largely eliminated so that, in combination with the additional degrees of freedom available here, the overall error of the imaging optics of the entire apparatus can be reduced or minimized in a particularly advantageous way.

Accordingly, a lens is fixed in its mount with the aid of a resilient means in such a way that the mechanical stresses in the lens due to the lens mount are largely avoided. As a result, imaging errors due to mechanical stresses in the optical components can be largely eliminated.

The initially mentioned object of the present invention is also solved by a method comprising the steps of:
detecting one or multi-dimensional image data of the object with the aid of a detection means;
storing the image data in a memory, wherein the object or part of the object is detected at least twice with the aid of the detection means;
rotating between two object detection processes, an optical component about its optical axis or is pivoting the optical component with respect to the optical axis of the optical path in which the optical component is arranged, or translating the optical component in a direction transverse to the optical axis; and,
obtaining extensive object information of improved quality by means of the detected image data of the at least two object detection processes.

Accordingly, the present invention also relates to a method of optically detecting an object with an apparatus. The apparatus for optically detecting an object, comprising a light source to illuminate an object, an illumination optical path, a detection optical path, imaging optics, a detection means, wherein the imaging optics are arranged in the detection optical path and wherein light coming from the object can be imaged onto the detection means with the aid of the imaging optics, an adjustment means is provided, by means of which at least one imaging optical component, arranged in the illumination optical path or in the detection optical path, wherein the at least one imaging optical component is rotatable about its respective optical axes, or is pivotable with respect to the optical axis of the optical path in which the optical component is arranged, and is translatable in a direction transverse to the optical axis, to detect an object with the aid of the optical component in a rotated, pivoted or translated state.

One and/or more dimensional image data of the object are detected and stored in memory with the aid of the detection means. An object or a part of an object is detected at least twice with the detection means, and the detected image data are stored in memory.

The method according to the present invention is characterized in that between two object detection processes an optical component is rotated about its optical axis, and/or is pivoted with respect to the optical axis of the optical path in which the optical component is arranged, and/or is translated in a direction transverse to the optical axis. The detected image data of the at least two object detection processes can serve to obtain more extensive high-quality object information.

In particular, as mentioned above, if with ultrafine-resolution applications the relative positions of the optical components arranged on the apparatus are changed during operation, such as by changing environmental conditions, the changes in the imaging characteristics caused in this way can be at least substantially compensated by adjusting or aligning at least one optical component of the apparatus. When the method of the present invention is applied, in any case the detected and stored image data can be compared, for example, by means of digital image processing techniques so that it can be determined whether or not and to what degree there has been a change in the optical imaging characteristics of the apparatus. If indeed a change in the optical imaging characteristics of the apparatus has been determined, it can also be determined, if necessary, which of the optical components is responsible for the change, and this optical component can be aligned in the manner according to the present invention. Hereafter the same object can be detected again and the image data of this detection process can be compared once more with the previously detected image data to determine, for example, whether the change in the optical imaging characteristics of the apparatus has been compensated by aligning the optical component.

For improving the quality of the detected image data it is also conceivable to use the reconstruction techniques of digital image processing. This could be done, in particular, with regard to the empirically determined or calculated transfer function of the optical components. In particular, the optical transfer function of the microscope lens can be taken into account.

### BRIEF DESCRIPTION OF THE DRAWINGS

There are now various possibilities to advantageously implement and develop the teachings of the present invention. Reference is made on the one hand to the patent claims depending on Claims 1 and 16 and on the other hand to the following explanation of the preferred embodiments of the invention with reference to the accompanying drawings. Together with the explanation of the preferred embodiments of the invention, generally preferred embodiments and developments of the teaching are also explained with reference to the drawings, in which:

FIG. 1 is a schematic representation of an exemplary embodiment of an apparatus according to the present invention; and,

FIG. 2 is a schematic representation of an exemplary embodiment of an adjustment means for pivoting and rotating an optical component of an apparatus.

### DETAILED DESCRIPTION OF THE INVENTION

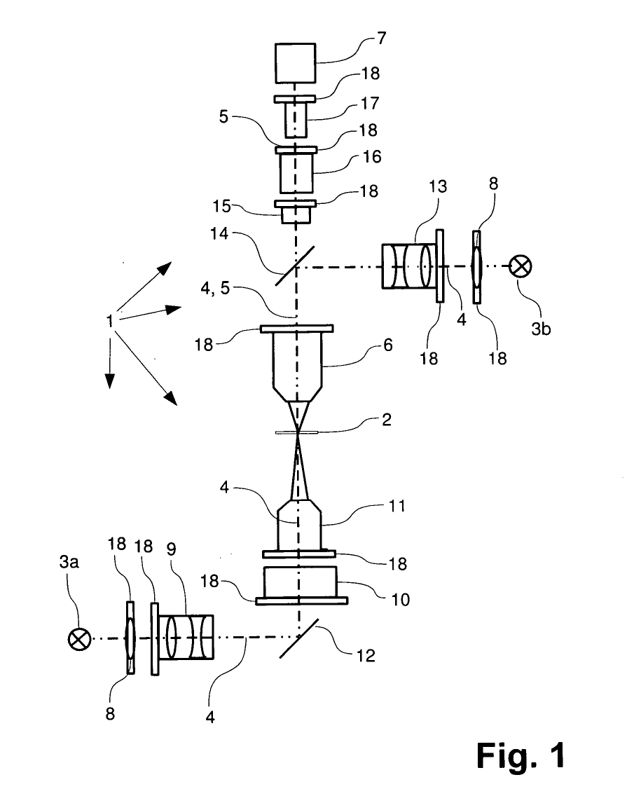

FIG. 1 shows an exemplary embodiment of an apparatus 1 according to the present invention for detecting an object 2. Apparatus 1 comprises two light sources 3a, 3b, an illumination optical path 4, a detection optical path 5, imaging optics 6 in the form of a microscope lens, and a detection means 7 in the form of a CCD camera. Apparatus 1 serves to detect object 2 by means of transmitted-light and/or incident-light illumination. To detect object 2 in the transmitted-light mode, object 2 is lighted by light source 3a. To detect object 2 in the incident-light mode, object 2 is lighted by light source 3b. Correspondingly, the illumination optical path 4 for the transmitted-light illumination extends from light source 3a to object 2. The illumination optical path 4 for the incident-light illumination extends from light source 3b to object 2. The detection optical path 5 extends from object 2 to detecting means 7.

The light emitted by light source 3a is at least partially collected by collector 8 and passes in sequence through intermediate or transportation optics 9, light mixer 10 and condenser 11. Between transportation optics 9 and light mixer 10, a mirror 12 is arranged, by means of which the light from light source 3a can be reflected towards condenser 11. Light mixer 10, in the present exemplary embodiment, has a micro-lens matrix; however, other forms are also possible. A light mixer is for homogeneously illuminating the object (the field plane). The term “homogeneously” is used in the present context to mean that at least the intensity measured in the object plane (field of vision, field) is extremely constant depending on the position, if no absorbing object is present. Moreover, in certain (advantageous) cases, constant illumination as a function of the direction of the light beam (pupil) is also needed. Similarly, the light emitted by light source 3b is at least partially collected by collector 8 and passes through intermediate optics 13 and is reflected at beam splitter 14 towards imaging optics 6.

The light from object 2 is at least partially collected by imaging optics 6 and passes, in sequence, through beam splitter 14, compensation element 15, tubular optics 16 and reenlargement optics 17, until it is finally detected by detecting means 7. In a practical implementation, apparatus 1 shown in FIG. 1 is an inspection microscope serving to detect substrates, wafers or masks in the semiconductor industry.

According to the invention an adjustment means 18 is provided in each case, in which an imaging optical component arranged in the illumination optical path 4 and/or in the detecting optical path 5 is arranged

a) to be rotatable about its respective optical axis;

b) to be pivotable with respect to the optical axis of the optical path 4, 5, in which the optical component is arranged; and,

c) to be translatable in a direction transverse to the optical axis to detect an object 2 with the optical component which is rotatably, pivotably and/or translatably adjusted.

In a practical implementation the following optical components in the illumination optical path 4 are each provided with an adjustment means 18 and therefore in each case able to be aligned in the manner according to the present invention: collector 8, transportation optics 9, light mixer 10, condenser 11 and intermediate optics 13.

The following optical components in the detection optical path 5 are each provided with an adjustment means 18 and are therefore also able to be aligned in each case in the manner of the present invention: compensation element 15, tubular optics 16 and reenlargement optics 17.

Imaging optics 6 arranged in both the illumination optical path 4 and in the detection optical path 5 is also provided with an adjustment means 18 and can also be aligned relative to apparatus 1 as well as to the other optical components.

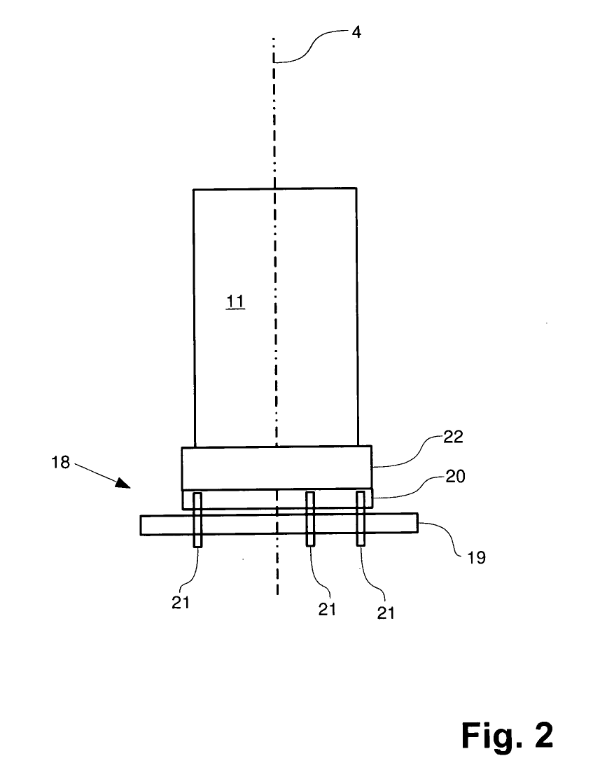

FIG. 2 schematically shows an exemplary embodiment of an adjustment means 18 with the aid of which condenser 11 can be aligned. Adjustment means 18 comprises a mounting interface 19 with which adjustment means 18 and the optical component, in the present case, condenser 11, can be mounted on apparatus 1. In this way mounting interface 19 having an annular configuration or a through hole for the light beams is fixedly coupled with apparatus 1, for example, with a housing portion or on the stand. It is only schematically shown that an intermediate ring 20 is connected to mounting interface 19 via three adjustment elements 21. In a practical implementation, adjustment elements 21 can be in the form of screws by means of which the space between intermediate ring 20 and mounting interface 19 is adjustable at each position of adjustment elements 21. Sleeve 22 is fixedly connected with intermediate ring 20. Intermediate ring 20 and sleeve 22 can also be combined in a single component. A bearing not shown in FIG. 2 is provided between sleeve 22 and condenser 11, enabling the condenser 11 to be rotated about the optical axis of the illumination optical path 4 relative to sleeve 22.

While adjustment means 18 of FIG. 2 is also configured as translatable in a direction transverse to the optical axis of the illumination optical path 4, the components, which make this possible, are not shown in FIG. 2.

Finally, it should be noted, in particular, that the above discussed exemplary embodiments only serve to describe a claimed teaching which is not, however, limited to these exemplary embodiments.

What is claimed is:

1. An apparatus for optically detecting an object, comprising a light source to illuminate an object, an illumination optical path, a detection optical path, imaging optics, a detection means, wherein the imaging optics is arranged in the detection optical path and wherein light coming from the object can be imaged onto the detection means with the aid of the imaging optics, an adjustment means is provided, by means of which at least one imaging optical component, arranged in the illumination optical path or in the detection optical path, wherein the at least one imaging optical component is rotatable about its respective optical axes, or is pivotable with respect to the optical axis of the optical path in which the optical component is arranged, and is translatable in a direction transverse to the optical axis, to detect an object with the aid of the optical component in a rotated, pivoted or translated state.

2. The apparatus according to claim 1, wherein said adjustment means is configured such that when the optical component is rotated, pivoted or translated, a focusing adjustment of the optical component or the entire apparatus remains essentially unchanged.

3. The apparatus according to claim 1, wherein the optical component comprises imaging optics, in particular a microscope lens.

4. The apparatus according to claim 1, wherein the optical component comprises a condenser arranged in the illumination optical path or transportation optics or a light mixer.

5. The apparatus according to claim 1, wherein the optical component is tubular optics arranged in the detection optical path or reenlargement optics or an optical compensation element.

6. The apparatus according to claim 1, wherein with the aid of the adjustment means, the optical component is arranged to be pivotable about at least two pivoting axes of differing spatial orientation and in that the pivoting can be effected, in particular, by means of a piezo actuator or by means of a mechanical actuator.

7. The apparatus according to claim 1, wherein an adjustment of the optical components can be carried out in such a way that an error minimization of the optical components of the apparatus is achievable preferably during the operation of the apparatus, in particular, as a calibration step, in particular, in such a way that minimum values of the X-Y bias are achievable.

8. The apparatus according to claim 1, wherein the optical component comprises a support for at least one optical component, such as a lens, and a mounting interface, in that the optical component is received by the support, in that the optical component received by the support has an optical axis, in that the optical component is mountable on the apparatus with the aid of the mounting interface, and in that the support is rotatable relative to the mounting interface with the aid of the adjustment means so that the optical component received by the support can be rotated about the optical axis in a state of the optical components mounted on the apparatus.

9. The apparatus according to claim 8, wherein the mounting interface comprises a thread or an interface similar to a bayonet mount, with which the optical components can be mounted on the apparatus.

10. The apparatus according to claim 1, wherein the optical component has at least one lens mounted in a mounting ring, and in that the mounting ring is received in the support, in particular, in a precise fit.

11. The apparatus according to claim 1, wherein said adjustment means (B) is a ball bearing, a grease bearing and/or a journal bearing.

12. The apparatus according to claim 1, wherein said adjustment means comprises a sleeve extending in the direction of the optical axis at least partially over the support, and which preferably comprises a mounting interface.

13. The apparatus according to claim 12, wherein the sleeve has a shoulder, on the inside, on its side facing the support, in that the support has another shoulder, on the outside, on its side facing the sleeve, and in that, in the assembled state, the two shoulders come into abutment with each other via a bearing, preferably effective in the direction of the optical axis, and in that between the sleeve and the support at least one area is provided which is formed as a journal or grease bearing.

14. The apparatus according to claim 1, wherein an angular area about which the support is rotatable, is provided which ranges from 0 degrees to at least 90 degrees, preferably from 0 degrees to 360 degrees.

15. The apparatus according to claim 1, wherein the apparatus comprises a coordinate measurement device, an inspection microscope for inspecting substrates for the semiconductor industry, an ultrafine-resolution microscope, a confocal scanning microscope or a double confocal scanning microscope.

16. A method of optically detecting an object with an apparatus, wherein the apparatus has at least one adjustment means, wherein the method comprises the steps of:
detecting one or multi-dimensional image data of the object with the aid of a detection means;
storing the image data in a memory, wherein the object or part of the object is detected at least twice with the aid of the detection means;
rotating between two object detection processes, an optical component about its optical axis or is pivoting the optical component with respect to the optical axis of the optical path in which the optical component is arranged, or translating the optical component in a direction transverse to the optical axis, and,
obtaining extensive object information of improved quality by means of the detected image data of the at least two object detection processes.

17. The method according to claim 16, wherein reconstruction techniques of digital image processing are applied, in particular, taking into account the empirically determined optical transfer function of the optical components, in particular, of the microscope lens.
